(19) United States
(12) Patent Application Publication
(10) Pub. No.: US 2015/0271267 A1
(43) Pub. Date: Sep. 24, 2015

(54) CONTENT-ORIENTED FEDERATED OBJECT STORE

(71) Applicant: Palo Alto Research Center Incorporated, Palo Alto, CA (US)

(72) Inventors: Ignacio Solis, South San Francisco, CA (US); Marc E. Mosko, Santa Cruz, CA (US)

(73) Assignee: Palo Alto Research Center Incorporated, Palo Alto, CA (US)

(21) Appl. No.: 14/223,866

(22) Filed: Mar. 24, 2014

(51) Int. Cl. H04L 29/08

(52) U.S. Cl. CPC H04L 67/1097

(57) ABSTRACT

A content-oriented federated object store facilitates processing queries on metadata from a collection of content objects. During operation, the system can receive, from a first entity, a query that includes one or more search parameters. The first entity can include a local application, or a peer network device. The system can analyze a local metadata repository to search for metadata entries that satisfy the query, such that the metadata repository can include metadata entries for a plurality of content objects. The system can also issue the query to a remote network device, to obtain search results from a metadata repository at the remote network device, or at a device accessible from the remote network device. If the system obtains a set of search results from the local metadata repository or from a remote metadata repository, the system returns the set of search results to the first entity.

### BACKGROUND

1. Field

This disclosure is generally related to data storage systems. More specifically, this disclosure is related to using distributed instances of a federated object store to search for, monitor, access, and share, content objects based on their metadata.

2. Related Art

Advancements in cellular and broadband data networks has allowed people or software applications to use server clusters as remote storage systems. Some users leverage these server clusters as a unified remote storage system for their various personal computing devices, which makes it easier to synchronize their data across their devices. Also, many software applications leverage these server clusters to aggregate data from a wide user base, or for storing web content or multimedia files that are to be consumed by their user base. These remote storage systems are oftentimes referred to as “the cloud,” which serves as an abstract label that hides the implementation details for how such a server cluster can store data for many clients across a collection of distributed storage servers.

Oftentimes, a “cloud” storage system is implemented using an object storage system that stores files in a flat organization, instead of organizing files in a directory hierarchy. For example, the Simple Storage Service (S3) from Amazon.com, Inc. of Seattle, Wash. organizes files in a flat organization of containers called “buckets”, and uses unique identifiers called “keys” to retrieve these files. These object storage systems require less metadata than typical file systems to store and access files, and they reduce the overhead of managing file metadata by storing the metadata with the object. Another advantage of these object storage system is that additional storage space can be added to the object storage system by adding additional nodes to the system.

Some object storage systems implement a distributed architecture. For example, the HC2 system from TierraCloud Technologies, Pvt. Ltd. of Bangalore India implements a distributed object storage system that does not include a master node to control where data is stored. However, the distributed nodes of the HC2 system are designed to combine with each other to create a single management entity that is owned and managed by one operator. If different users were to deploy their own independent instances of the HC2 system, these two instances would not be able to interface with each other without first combining these two entities into a single management entity.

### SUMMARY

One embodiment provides a content-oriented federated file system that facilitates processing queries on metadata from a collection of content objects. During operation, the system can receive, from a first entity, a request message that includes a command for an object store system, a payload, and user metadata. If the system determines that the command includes a command to store the payload in the object store system, the system processes the command to split the payload into a set of user-data named content objects, and stores the user-data content objects in a data repository. The system can also create a user-metadata named content object from the user metadata, and can generate a system-metadata named content object for system contextual metadata associated with the named content objects. The system then stores the metadata content objects in a metadata repository that includes metadata for a plurality of user-data content objects.

The system can assign three names to the user-data named content objects. These names can include a globally unique name (e.g., a hash-based name or other self-certifying name), a name generated from the user level name, and a contextual name derived from the system metadata. The system stores these names in a system-metadata repository.

The system may decide to store the metadata and content in different locations. The metadata is structured such that the object storage system and any other federated instances can understand the metadata. The metadata may be formatted in a key-value store format. Each Key in the metadata is a globally understood key from a globally coordinated key space. Part of this key space is assignable to the different entities that can sub-divide the key space.

In some embodiments, the command can include a command to access data from the object store system. The system can process the command and metadata to searching through the local metadata repository to identify user-data content objects that match the metadata in the request message. The system obtains the identified user-data content objects from the data repository, and obtains user-metadata that corresponds to the identified user-data content objects from the local metadata repository. The system can assemble the obtained content objects into a response payload, and sends a response message that includes at least the response payload and the user-metadata to the first entity.

In some embodiments, the system can validate the command, the user metadata, and the system metadata.

In some embodiments, the command can include one or more instructions selected from: a create command; an update command; an append command; a merge command; a read command; a search command; a delete command; an associate command; a move command; a notify command; a subscribe command; a publish command.

In some embodiments, the user metadata can includes one or more of: a content name; author information; group information; encryption information; authentication information; cryptographic signature information; a relation to other content names; format information; a creation time; a modification time; a size; and a notification time.

In some embodiments, the system metadata includes one or more of: author information; group information; encryption information; authentication information; cryptographic signature information; a relation to other content names; format information; a creation time; a modification time; a size; a notification time; system identification information; system authentication information; system resource information; system connectivity and network information; and system peer information.

In some embodiments, the request message from the first entity can also include callback information for the first entity: and the response payload can also include callback information for the local computer device.

In some embodiments, the callback information includes one or more of: a callback function; a callback message queue; a storage location; a network address; a signal; a network socket; a file descriptor; a lock; a semaphore; and shared memory.

In some embodiments, the data repository or the metadata repository includes one or more of: a database; a random access memory (RAM) device; a non-volatile storage device; and a remote storage device.

In some embodiments, the command can include a command to access data from the object store system. The system can process the command to update the command in the request message to include a system context, and forwards the request message with the updated command to a second entity. The second entity can process the request massage, and returns a response message that includes at least a set of response payload content objects, and a user metadata content object. Once the system receives the response message from the second entity, the system forwards the response message to the first entity.

In some embodiments, the response message from the second entity can also include a system metadata content object, and a command response. The system can validate the command response and the system metadata content object from the response message prior to forwarding the response message to the first entity.

In some embodiments, the second entity includes one or more of: a local application; and a peer network device.

In some embodiments, the local entity and the second entity have exchanged authentication information.

In some embodiments, the system can communicate with the second entity over one or more of: an inter-process communicating (IPC); an Internet protocol (IP) network; and a content centric network (CCN).

### BRIEF DESCRIPTION OF THE FIGURES

FIG. 1 illustrates an exemplary network environment that facilitates managing access to information on content objects in accordance with an embodiment.

FIG. 2A illustrates a metadata repository in accordance with an embodiment.

FIG. 2B illustrates a metadata field in accordance with an embodiment.

FIG. 2C illustrates an exemplary inheritance tree for key types in accordance with an embodiment.

FIG. 3A illustrates a content object in accordance with an embodiment.

FIG. 3B illustrates a content object as stored by the federated object store in accordance with an embodiment.

FIG. 4 illustrates a distributed architecture for a federated object store in accordance with an embodiment.

FIG. 5A presents a flow chart illustrating a method for processing a search query in accordance with an embodiment.

FIG. 5B presents a flow chart illustrating a method for monitoring a content object that matches query criteria in accordance with the embodiment.

FIG. 5C presents a flow chart illustrating a method for searching for one more content objects that match search criteria in accordance with an embodiment.

FIG. 6 presents a flow chart illustrating a method for evaluating a query's permission to access a storage object in accordance with an embodiment.

FIG. 7 presents a flow chart illustrating a method for storing information of a content object in one or more repositories in accordance with an embodiment.

FIG. 8 illustrates an exemplary apparatus that facilitates managing access to content objects or metadata of the content objects in accordance with an embodiment.

FIG. 9 illustrates an exemplary computer system that facilitates managing access to content objects or metadata of the content objects in accordance with an embodiment.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention provide a system that implements a content-oriented federated object store that solves the problem of monitoring or searching for content objects based on the content object's metadata, without accessing the content object's data. The object store system can run on multiple computers as a federated object store, so that a search for data that initiates at one computer can be performed on multiple computers. These multiple computers do not need to be part of the same administrative domain, nor do they need to be owned or managed by the same user. For example, operating systems or other software running on people's personal computing devices can run an instance of the federated object store, which allows these devices to query each other for data.

Each instance of the content-oriented federated object store can use access control information to determine which search queries the object store can process, and to determine the data that can be returned by the search query. This way, when a user or an application initiates a search on one computer, this search query can propagate to other computers whose access control information allow the user or application to search for data.

In some embodiments, an instance of the federated object store implements an application programming interface (API) that allows local applications to submit queries to the federated object store. The object store system can also use the API at other instances of the federated object store at other computers to forward the request to the other computers. For example, users and applications can register themselves to the federated object store, or at least to one or more instances of the object store. Registering an entity can establish a unique identifier for the entity. Then, when the entity issues a query via the API, the query can include the entity's identifying information, and can include permissions information for the entity.

When the object store instance receives the query, the object store instance can obtain the entity's identifying information from the query. The object store instance then analyzes this entity's permissions information along with the local access control information to determine whether the entity is allowed to access the local API, and/or to determine which types of data or pieces of data the entity is allowed to access. In some embodiments, in order for one computer to issue a query to another computer, the object store instances at these two computers need to agree on permissions. For example, the permissions can be cryptographically enforced at the two computers. Also, the data exchanged between object store instances can be exchanged in encrypted form, where only authorized entities have the necessary key to decrypt the data.

The object store API can process two types of queries: a “monitor” query and a “search” query. The monitor query can specify an object to monitor, which causes the object store to push, to the requesting entity, any events that occur on the object being monitored. The monitor query can be persistent (e.g., can be stored at the target object store instance), and can include a set of qualifiers that specify the event types to push to the requesting entity. The search query, on the other hand, can specify criteria to use for searching for one or more content objects whose metadata match the search criteria. The search results can include a listing of the matching content objects, or can include the content objects themselves.

In some embodiments, the object store can process a query using only metadata on a content object, without reading or analyzing the content object's data. This is not possibly on typical data storage systems, given that a typical data stores store files that include both the file's data and metadata in the same file. In contrast, the federated object store can include a data repository that stores content data, and can include a metadata repository that stores metadata for the content data. This way, the federated object store can treat the metadata and the content data as separate entities. This allows the federated object store to perform queries on the metadata repository, without accessing the content objects' data in the data repository.

### Exemplary Computing Environment

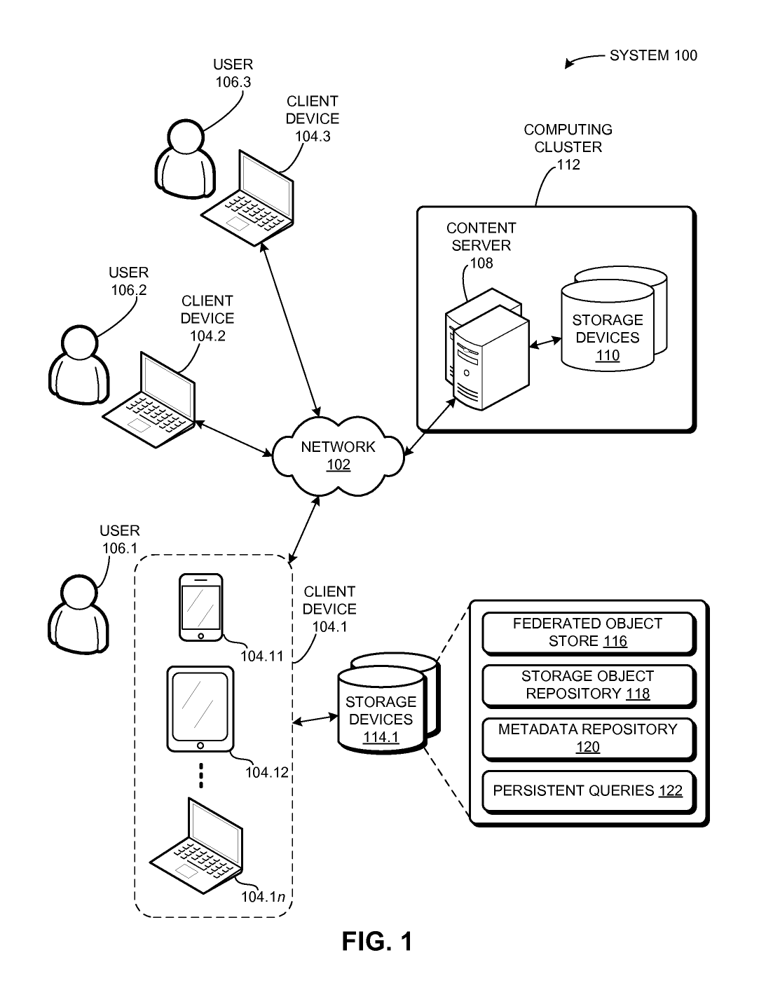

FIG. 1 illustrates an exemplary network environment 100 that facilitates managing access to information on content objects in accordance with an embodiment. Network environment 100 can include one or more network devices, such as client devices 104 and content servers 108 (e.g., servers in a computing cluster 112), that each run an instance of a federated object store. Client devices 104 and content servers 108 can issue queries to other network devices over a computer network 102, to monitor data or search for data that matches certain query attributes. Computer network 102 can include any wired or wireless network that interfaces various computing devices to each other, such as a computer network implemented via one or more technologies (e.g., Bluetooth, Wi-Fi, cellular, Ethernet, fiber-optic, etc.).

A client device 104 can include any computing device that a user 106 can use to create or access content, such as a smartphone, a tablet computer, a laptop, or any other personal computing device. Content servers 108 can include network devices in a computing cluster 112, such as cloud storage servers. Client devices 104 and content servers 108 can store data for one or more users, and can store metadata for this stored data. For example, a client device 104.1 can include or be coupled to a storage device 114.1 that stores a federated object store 116, a storage object repository 118, a metadata repository 120, as well as persistent queries 122. Storage object repository 118 can include a plurality of storage objects, such that a piece of data (e.g., a document, a media file, etc.) is partitioned and stored in repository 118 as one or more storage objects. Also, metadata repository 120 can store metadata for the data stored in storage object repository 118. Content servers 108 can also be coupled to storage devices 110, which can also store a federated object store, a storage object repository, a metadata repository, and persistent queries.

A network device 104 or 108 can issue queries over a computer network 102 to other object store instances, or can process queries received from other object store instances. The network device can receive or issue a monitor query to obtain event information each time a content object is accessed (e.g., to create, read, modify, or delete an instance of the content object), either locally or at a remote instance of the federated object store. The network device can also receive or issue a search query to obtain metadata for content objects that satisfy certain search attributes.

In some embodiments, a computing device can obtain metadata from a content object being stored in the federated object store. The computing device can provide this metadata and the content object to a local instance of the federated object store via the federated object store's API. The federated object store stores this metadata within a metadata repository, and stores the content object within a storage object repository that is separate from the metadata repository.

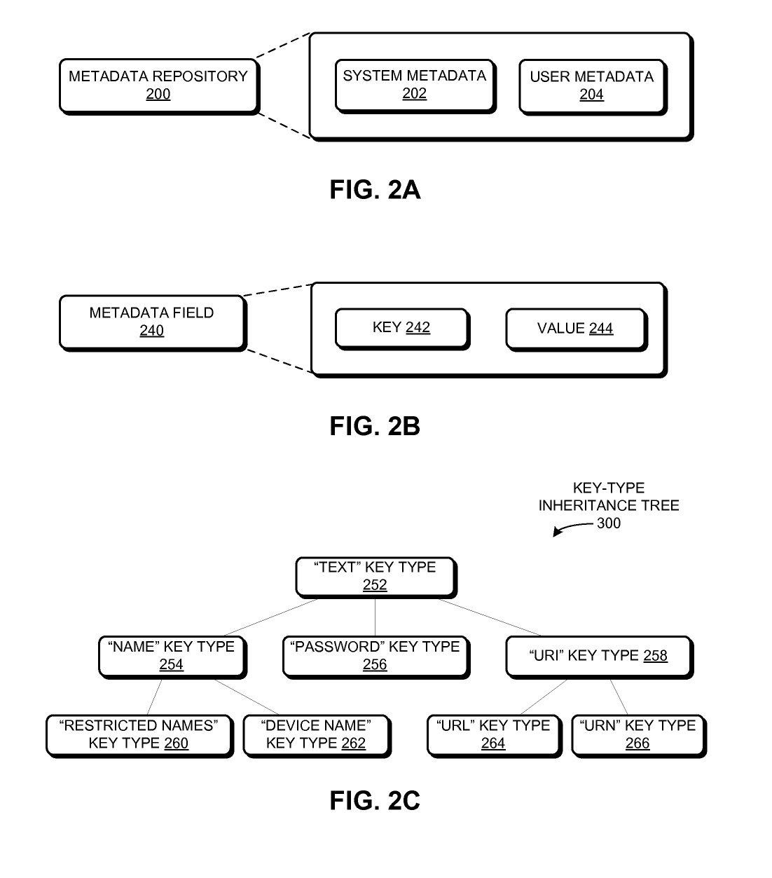

FIG. 2A illustrates a metadata repository 200 in accordance with an embodiment. Specifically, metadata repository 200 can include system metadata 202 and user metadata 204. System metadata 200 can include information used by the object store to keep track of a content object, and to determine access privileges for the content object. For example, system metadata 202 can include information for the content object, such as an object creation time, an object modification time, an object size, an object format, an author that created the content object, a user group or domain for the content object, a notification time, and a relation to other content names. System metadata 202 can also include security-related information, such as encryption information, authentication information, and cryptographic signature information. System metadata 202 can also include system related information, such as system identification information, system authentication information, system resource information, system connectivity and network information, and system peer information.

In some embodiments, the object store instance can assign three names to the user-data named content objects. These names can include a globally unique name (e.g., a hash-based name or other self-certifying name), a name generated from the user level name, and a contextual name derived from the system metadata. The object store instance can store these names in system metadata repository 202.

User metadata 204 can include any localization information about a content object, such as keywords that characterize the content object's contents. For example, user metadata 204 can include a content name, author information, group information, format information, a creation time, a modification time, an object size, a notification time, encryption information, authentication information, cryptographic signature information, and a relation to other content names. A user or application can create, read, modify, or delete (CRUD) user metadata entries for a content object by issuing a CRUD command via the object store's API. In some embodiments, the user or application needs to provide a valid unique identifier or authorization information that grants the user or application permission to access the API, or to create, read, modify, or delete the metadata entry. The object store instance can compare this user identifier or authorization information against access control information for the API, the content object, or the metadata objects to determine whether the user or application is authorized to access the API or the content object's metadata.

In some embodiments, the object store instance may store the metadata and named content objects in different locations. The metadata is structured such that the local object storage instance and/or any other federated instances can understand the metadata. For example, an object store instance can organize metadata 200 into key-value pairs. A key-value pair includes a key field that is designated a key type, and includes a value field that indicates a value for the key type. Each key in the metadata repository 200 is a globally understood key from a globally coordinated key space. Part of this key space is assignable to the different entities that can sub-divide the key space.

FIG. 2B illustrates a metadata field 240 in accordance with an embodiment. Specifically, metadata field 240 can store a key field 242 and a value field 244, which together form a key-value pair. The key field can include one or more rules that indicate valid values for the metadata field, such as a regular expression constraint, or a maximum and/or minimum string length. For example, key field 242 for system metadata may specify an “author” key type, and value field 244 can include a user name for the author that created a corresponding content object. As another example, a key field 242 for user metadata may specify a key type that characterizes the content object's data, such as “duration” for an audio or video media file, and value field 244 can specify a time duration for the media file.

In some embodiments, the federated object store instance can define a key's type to restrict the possible set of values for a metadata field. A key's type can be an inherited key type definition, whose possible values are inherited from a base key or a parent key. An inherited key type can also further restrict a metadata field's possible values.

FIG. 2C illustrates an exemplary inheritance tree 250 for key types in accordance with an embodiment. For example, a root key type 252 may include a “text” type, whose strings can include any sequence of characters. Other key types can inherit a key definition from “text” key type 252, such as a “name” key type 254, a “password” key type 256, and a “URI” key type 258. A definition for name key type 254 can further restrict the text key type 252, for example, to only include alphabetic characters, a subset of punctuation marks (e.g., a dash, a period, etc.), and restricts the name to a maximum string length. Other key types can also further restrict name key type 254, such as a “restricted names” key type 260 and a “device name” key type 262.

Password key type 256 can also restrict the possible “text” strings to only include characters from a predetermined set to form a valid password, and can require the password's length to be within a predetermined range. Password key type 256 can require a valid password to have a high strength, for example, by requiring the password to include characters from a set of rarely-used characters. A “URI” key type 258 can include a description of a valid uniform resource identifier, whose string of characters indicates a name for a network resource. A “URL” key type 264 can inherit restrictions from URI key type 258, and can include additional restrictions that define a uniform resource locator that identifies a resource by location (e.g., a web page). Similarly, a “URN” key type 266 can inherit restrictions from URI key type 258, and can include additional restrictions that define a uniform resource name that identifies a resource by name.

As mentioned earlier, an instance of the federated object store can receive a content object from a local application via an API. The federated object store can store the content object's data in a storage object repository, and stores the content object's metadata in a metadata repository that is separate from the storage object repository. This allows the federated object store to process queries on metadata for a user's data, without having to access the user's data itself.

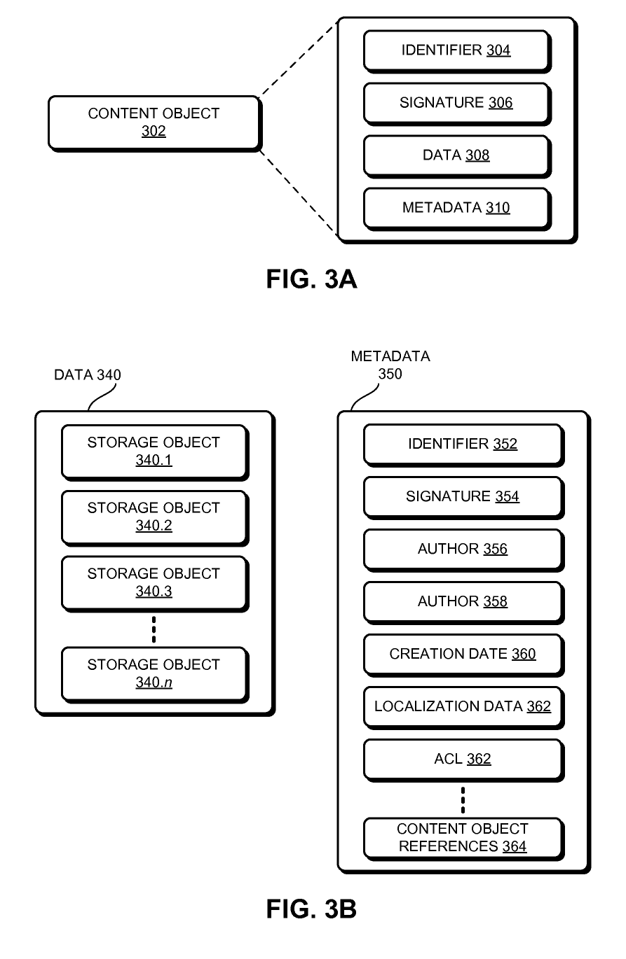

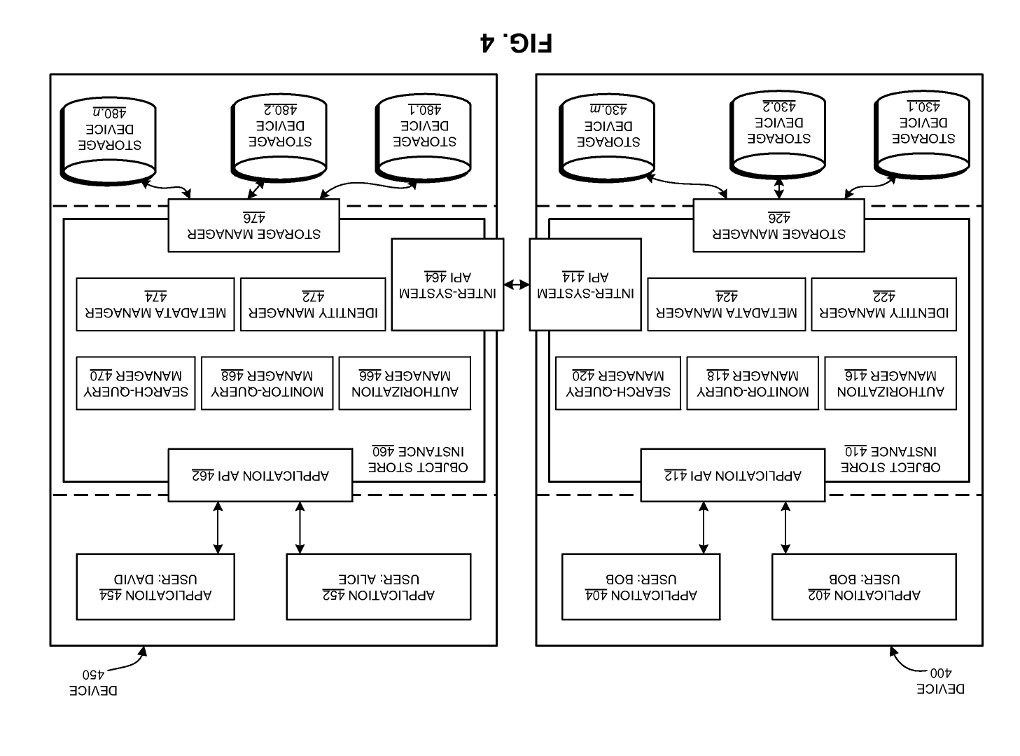

FIG. 3A illustrates a content object 302 in accordance with an embodiment. Specifically, content object 302 can include any typical piece of data, such as a document, an image file, a media file, etc. Content object 302 can contain an identifier 304, a signature 306, data 308, and metadata 310. The object store can store data 308 separate from all metadata for content object 302. For example, the object store can divide data 308 into a set of storage objects, and stores these storage objects in the storage object repository. The object store also gathers other additional data from content objet 302 (e.g., any data that is not content data 308), and stores this additional data into metadata repository in association with the content object. This additional data includes the explicit metadata 310, as well as identifier 304, and signature 306.

FIG. 3B illustrates a content object as stored by the federated object store in accordance with an embodiment. The object store divides data 340 from the content object into a set of storage objects 340.1-340.n, and stores storage objects 340 in the storage object repository. The object store also generates metadata 350 from any other information found in the content object, or provided by a user or application in association with the content object. In some embodiments, a content object's metadata may include a key that appears multiple times, such as to specify multiple authors. For example, metadata 350 can include information necessary for organizing and storing the content object, such as a content object identifier 352, a signature 354, two authors (e.g., authors 356 and 358), a creation date 360, and localization data 362. Metadata 350 can also include an access control list (ACL) 362, which provides accessibility information for the content object's data and/or metadata.

In some embodiments, metadata 350 can include content object references 364, which can indicate an association to a different content object. For example, a document's metadata can include content object references 364 that indicate prior versions of the document, and/or to later versions of the document. An exemplary content object reference for a file “F0” may indicate that file F0 is a “prior version of” file F1. Similarly, exemplary content object reference for file F1 may indicate that file F1 is a “next version of” file F0.

FIG. 4 illustrates a distributed architecture for a federated object store in accordance with an embodiment. Specifically, a device 400 can include an object store instance 410, a set of storage devices 430, and local applications 402 and 404 that are being used by a local user “Bob.” Object store instance 410 can include an application API (application programming interface) 412, which allows applications 402 and 404 to issue queries for monitoring or searching for content objects stored by object store instance 410. Applications 402 and 404 can also use application API 412 to create, read, update, or delete content objects via object store instance 410.

In some embodiments, each user may operate one or more applications that can access the application API. For example, on device 400, a user Bob can use both applications 402 and 404 that issue queries on behalf of Bob. Application 402 or application 404 can issue a query via application API 412 by including permission information for user Bob in the query. Similarly, on device 450, a user Alice can use an application 452, and a user David can use an application 454. When the object store instance processes an application's query to obtain query results, the object store instance compares the permission information in the query (which is specific to the application's user) to the ACL of the query results to determine which results can be returned to the application.

Object store instance 410 can also include an inter-system API 414, which object store instance 410 can use to issue a query to an object store instance at a peer network device. For example, after object store instance 410 receives a query from user Bob, object store instance 410 can generate a set of results from local data, and can obtain additional query results by issuing the query to object store instance 460 via inter-system API 464 of object store instance 460. Object store instance 460 compares the user permissions information in the query to the ACL of the local query results to determine which results can be returned to object store instance 410. Object store instance 460 can return the query results to object store instance 410 via inter-system API 414 of object store instance 410. If the query is a “monitor” query, object store 460 can use inter-system API 410 to push events that match the query's criteria to object store 410. Note that applications 402 and 404 are not aware of the network interactions between object store instances 410 and 460. Applications 402 and 404 are only interested in searching for content, or obtaining content, regardless where the content is stored, or who is modifying the content.

Object store instance 410 can use inter-system API 414 to communicate with other object store instances as peer-to-peer nodes, or by forming an ad-hoc network of peer network nodes. For example, devices 400 and 450 can join a common local area network (LAN) or Wi-Fi network, and object store instances 410 and 460 can detect each other in the local network. This allows object store instances 410 and 460 to communicate with each other directly via inter-system APIs 414 and 464. Also, devices 400 and 450 may each have a network connection with other network nodes, which they can use to form an ad-hoc network. Object store instances 410 and 460 can propagate queries to these other network nodes, if the query includes permission information that allows them to access and to be propagated to the other network nodes. Object store instances can also use an inter-system API to communicate with devices over any other computer network, such as over a Transmission Control Protocol and Internet Protocol (TCP/IP) network (e.g., over the Internet), or over a content-centric network (CCN). Alternatively, object store instances 410 and 460 can use inter-system API to issue queries or commands to a central server that helps proxy communication between two or more federated object store instances.

In some embodiments, object store instance 410 can communicate with applications 402-404 and/or with object store instance 460 over one or more of an inter-process communicating (IPC), an Internet protocol (IP) network, and a content centric network (CCN). For example, application API 412 and/or inter-system API 414 can communicate with other entities over IPC, an IP network, and/or CCN.

In some embodiments, object store instance 410 and object store instance 460 need to exchange and agree on permissions in order to share information with each other. For example, when instance 410 issues a query to instance 460, instance 410 needs to submit permission information that matches an ACL at instance 460 (e.g., an ACL for data that satisfies the query). Also, recall that instance 460 can return the results that immediately match the query (e.g., for a search query), or can “push” results that match the query at a later time (e.g., for a monitor query). In order for instance 460 to send results to instance 410, instance 460 needs to provide permissions information that grants instance 460 permission to create or write data to instance 410 via inter-system API 414. The permission information provided in a query or in query results can be cryptographically enforced. For example, instance 460 can encrypt the permissions information with a local private key, and instance 460 can decrypt the permissions information using a decryption key from a digital certificate for instance 460.

In some embodiments, object store instances 410 and 460 can be associated with the same entity. For example, a user can deploy a object store instance across various personal computing devices, and may configure these distributed object store instances to operate as a single unit. Doing so can allow object store instance 410 on device 400 and object store instance 460 on device 450 to mirror each other's repositories to implement failover redundancy.

An object store instance can include a set of data-managing modules that facilitate storing, querying, and securing content objects. Object store instance 410 can include an authorization manager 416, a monitor-query manager 418, a search-query manager 420, an identity manager 422, a metadata manger 424, and a storage manager 426. During operation, authorization manager 416 can analyze permission information from queries received from application API 412 or inter-system API 414 to deny queries from any entities that are not authorized to issue a query to object store instance 410. Object store instance 410 can also analyze ACL information from a query's results to remove any data that the query is not permitted to access.

Monitor-query manager 418 can process a monitor query that was received via application API 412 or from a remote object store instance via inter-system API 414. A monitor query can be persistent and event-driven, which means that monitor-query manager 418 can store the monitor query for a determinable time period, and can return data for any object events that matches the monitor query's criteria. Since the monitor query is persistent, the query can indicate when to send query results (e.g., a time frame), can qualify a number of events to return (e.g., a maximum number of events), and can qualify a frequency for sending query results (e.g., send only the first matching event, or send any matching events every n minutes).

The monitor query can also be stored by the source entity that issues the query, and by any object store instance that is cooperating to generate search results for the source entity. For example, the search query can have a unique query identifier, and can propagate through a chain of network nodes that are running an instance of the federated object store. These network nodes can store the search query in association with the query identifier, and can generate search results that include the query identifier. Monitor-query manager 418 can generate the query identifier, for example, by combining a unique identifier of the sender and a query number. Once the monitor query has expired, monitor-query manager 418 can delete the stored copy of the monitor query to stop returning data that matches the query criteria.

Search-query manager 420 can process a search query that was received via application API 412 or via inter-system API 414. Search-query manager 420 can process the search query by searching the metadata repository for content objects that match the query criteria, without searching through the content objects themselves (e.g., without searching through the storage object repository). An example search query can include as criteria an author “Ignacio Solis,” and a creation date of 1 Jan. 2011 or later. Search-query manager 420 can process this query to return any content objects that were authored by Ignacio Solis on or after 1 Jan. 2011. If matching content objects exist, search-query manager 420 can create the query results to include the matching content objects themselves, or can create the query results to include a list of the matching content objects.

On the other hand, if a matching content object does not exist, search-query manager 420 can return empty results. Alternatively, a search query can be non-blocking and event-driven. Search-query manager 420 can store the search query in a list of pending search queries. Once search-query manager 420 detects a matching content object, search-query manager 420 can push the matching content object (or information on the content object) to the entity that issued the search query. For example, an application can generate a search query that includes a parameter indicating that the search query is non-blocking. This allows the application to monitor when a content object that matches the query criteria has been created. Once a matching content object is created, or an existing content object is modified to match the search criteria, search-query manager 420 can process the content object's ACL using the search query's permission information to determine whether the requesting entity has permission to receive the content object. If so, search-query monitor 420 can return the content object (or information on the matching content object) to the requesting entity.

In some embodiments, search-query manager 420 can delete a non-blocking search query once search results are returned to the requesting entity. Alternatively, the non-blocking search query can be persistent. This way, search-query manager 420 can retain the persistent search query to return matching search results for as long as the persistent search query has not expired or has not been deleted.

In some embodiments, a monitor query or a search query may not return the same results each time the query is issued. This is because the query indicates metadata attributes as search criteria that can be used to select any content object whose metadata matches the query's search criteria. Object store instance 410 can modify metadata for content objects as these content objects are created, updated, or deleted. This, in turn, causes the query results to vary over time as the metadata repository is updated over time.

Identity manager 422 can store identity information for a set of entities (e.g., a user or an application) that are allowed to issue queries to object store instance 410. Identity manager 422 can also store a digital certificate for each entity, which allows object store instance 410 to use a decryption key from an entity's digital certificate to authenticate a query or query results from the entity.

Metadata manager 424 can process a content object to extract metadata for the content object, and can store the metadata in a metadata repository in association with the content object. Metadata manager 424 can also query the metadata repository to determine metadata entries and/or content objects that satisfy certain criteria. Recall that a metadata entry includes a key field, and a value field. Metadata manager 424 can store definitions for a plurality of key fields, such that a given key type definition indicates one or more other key types from which the given key type inherits a key type definition, and can include one or more rules that further restrict the possible values for a metadata entry.

Storage manager 426 can manage access to one or more storage devices 430 that store content objects or metadata for object store instance 410. A storage device 430 can include a storage object repository and/or a metadata repository. For example, storage device 430 can include a database, a random access memory (RAM) device, a non-volatile storage device, or a remote storage device. When object store instance 410 receives a content object to store, object store instance 410 divides the content object's data into a set of storage objects, and stores these storage objects in the storage object repository. Object store instance 410 also determines metadata for the content object (e.g., by extracting the metadata from the content object), and stores the metadata in the metadata repository separate from the content object's data. In some embodiments, storage manager 426 can store storage objects or metadata across a plurality of storage devices 430 by striping the storage objects or metadata across the plurality of storage devices 430.

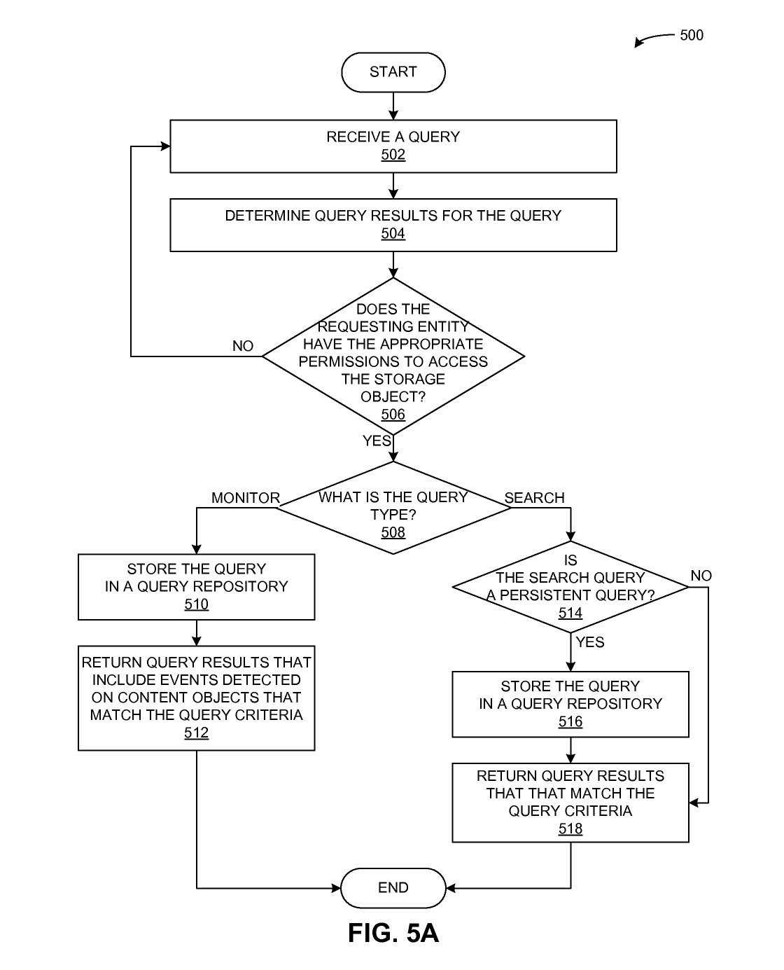

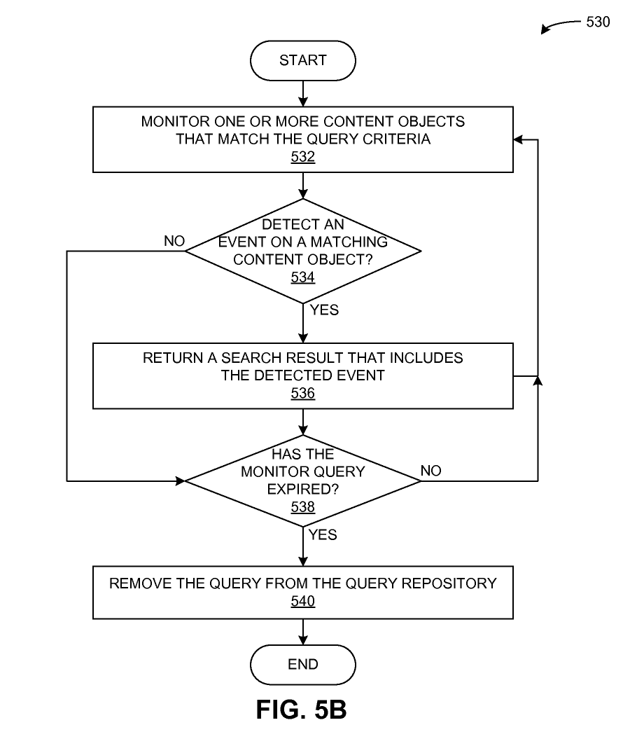

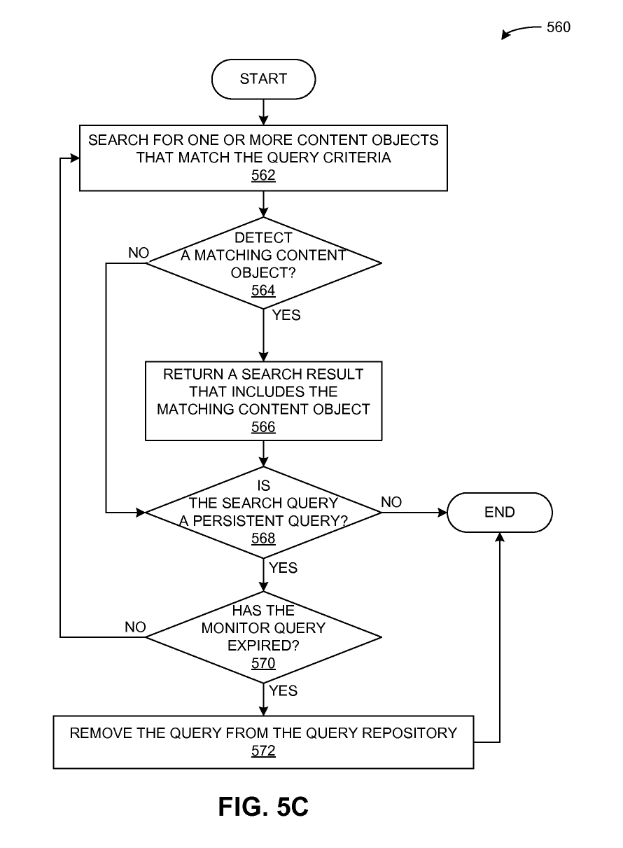

FIG. 5A presents a flow chart illustrating a method 500 for processing a search query in accordance with an embodiment. During operation, the system can receive a request message or query (operation 502), such as a monitor query or a search query from a local application or from a remote instance of a federated object store. The request message can include a command, a payload, user metadata, and callback information. For example, the command can include a command to store or update data in the federated object store, such as a create command, an update command, an append command, or a merge command. The command can also include a command to access data in the federated object store, such as a read command, a search command, a delete command, an associate command, a move command, a notify command, a subscribe command, or a publish command.

In some embodiments, the callback information can include a callback function; a callback message queue; a storage location; a network address; a signal; a network socket; a file descriptor; a lock; a semaphore; and shared memory.

Upon receiving the request, the system determines query results for the query (operation 504), and determines whether the requesting entity that submitted the query has the appropriate permissions to access the query results (operation 506). The system can also validate the command, the user metadata, and/or the system metadata provided in the request message. If the requesting entity does not have valid permission to receive the query results, or the contents of the request message are not valid, the system can return to operation 502 to receive another query.

If the requesting entity has the appropriate permissions, the system can determine the query type for the query (operation 508). If the query type is a monitor query, the system can store the monitor query in a query repository (operation 510), and returns the query results (operation 512). These query results can include events that are detected on content objects that match the query criteria.

On the other hand, if the query is a search query, the system can determine whether the query is a persistent query (operation 514). A persistent search query is a query that can be stored by the system to return a search result as soon as a content object satisfies the query's criteria. Hence, if the search query is a persistent query, the system can store the query in a query repository (operation 516), and returns the query results that match the query criteria (operation 518).

In some embodiments, the system can also forward the query to other instances of the federated object store. For example, the system can update the command in the request message to include a system context, and forwards the request message with the updated command to another entity. This other entity can include a local application, an application running on a peer network device, or another instance of the federated data store. This allows the other entity to process commands in the request message to monitor or search for content objects on behalf of the local system. Once the other entity generates a response, the local system can receive a response message from the other entity that can include a set of response payload content objects, and a user metadata content object. The local system can validate the contents of the response message (e.g., a response payload and the user metadata content object), and if the response message's contents are valid, can proceed to forward the response message to the requesting entity.

FIG. 5B presents a flow chart illustrating a method 530 for monitoring a content object that matches query criteria in accordance with the embodiment. During operation, the system can monitor one or more content objects that match the monitor query's criteria (operation 532). When the system detects an event on a matching content object (operation 534), the system can return a search result that includes the detected event (operation 536).

Recall that a monitor query can be persistent for a predetermined period of time, after which time the query can expire. The monitor query may expire if an application is permitted to only monitor a content object for a limited time, or is permitted to receive only a set number of object events. Hence, the system can periodically determine whether the monitor query has expired (operation 538). If the query has not expired, the system can return to operation 532 to monitor the content objects that match the monitor query's criteria. On the other hand, if the query has expired, the system can remove the query from the query repository to stop pushing information on events that match the query criteria (operation 540).

FIG. 5C presents a flow chart illustrating a method 560 for searching for one more content objects that match search criteria in accordance with an embodiment. During operation, the system can search for one or more content objects that match a search query's criteria (operation 562), and determines whether a matching content object has been detected (operation 564). If the system does detect a matching content object, the system returns a search result that includes the matching content object (operation 566).

The system then determines whether the search query is a persistent query (operation 568). Persistent queries allow the system to return content objects that match the query over time, such as when a new content object is stored or created, or when an existing content object is modified to match the search criteria. If the search query is not persistent, the system then halts sending content objects that match the search query. If the query is persistent, the system then determines whether the persistent query has expired (operation 570). If the system determines that the persistent search query has expired or has exhausted the number search events permitted, the system removes the persistent query from the query repository (operation 572). On the other hand, if the search query has not expired, the system can return to operation 562 to continue searching for content objects that match the query criteria.

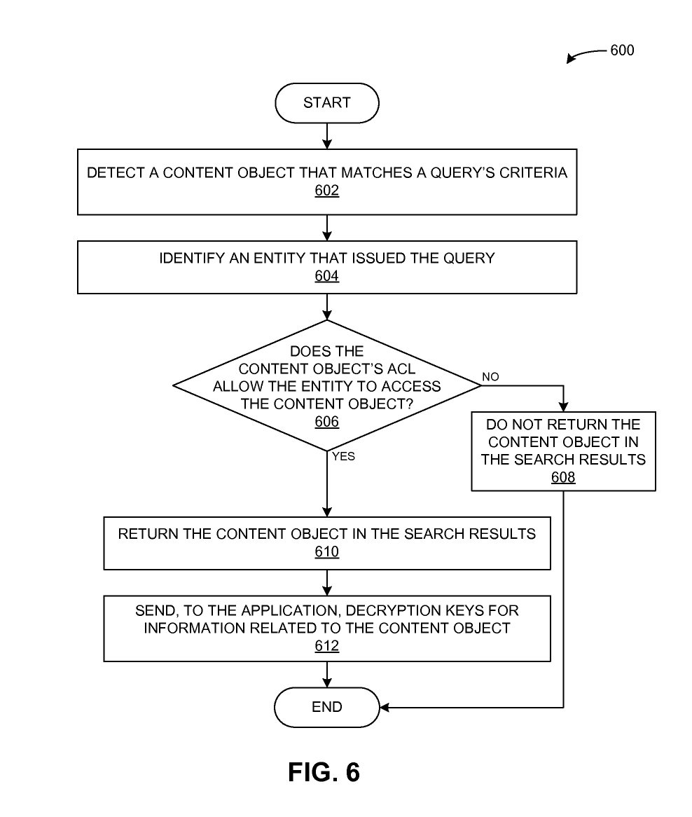

FIG. 6 presents a flow chart illustrating a method 600 for evaluating a query's permission to access a storage object in accordance with an embodiment. During operation, the system can detect a storage object that matches a query's criteria (operation 602), and identifies an entity that issued the query (operation 604). The entity can include a user, or an application that issued a query on the user's behalf. In some embodiments, the user or application that issued the query registers itself to the federated object store, and is assigned a unique identifier. Then when issuing a query, the entity needs to provide its identifying information to the federated object store. For example, the entity can perform a call to the application API to provide the entity's identity to the federated object store. If the local object store instance does not store the matching content objects, the system can use the inter-system API to issue the query and the entity's identity to another instance of the federated object store.

Once the system identifies the entity that issued the query, the system determines whether the metadata of the matching content object has an access control list (ACL) that allows the entity to access the content object's data (operation 606). If the content object's ACL does not grant the entity access, the system does not return the content object in the query results (operation 608). Otherwise, the system can return the content object in the query results (operation 610).

If the search results are encrypted, the system can also send, to the requesting entity, decryption keys for information related to the content object (operation 612). An application that issued the query can use the decryption keys to decrypt the search results, or to decrypt the content object itself. In some embodiments, to secure the content objects, the system only sends decryption keys to those applications that the content object's ACL authorizes to access the content object. System administrators or owners of the content objects can update the ACL to grant or deny access to certain users or applications as necessary. This provides both security and flexibility. For example, companies may authorize new users to access certain content objects as new employees join the company. Then, as soon as an employee quits or is terminated, the company can protect its confidential information by simply updating the content objects' ACLs to remove that employee's identifier from a list of authorized entities.

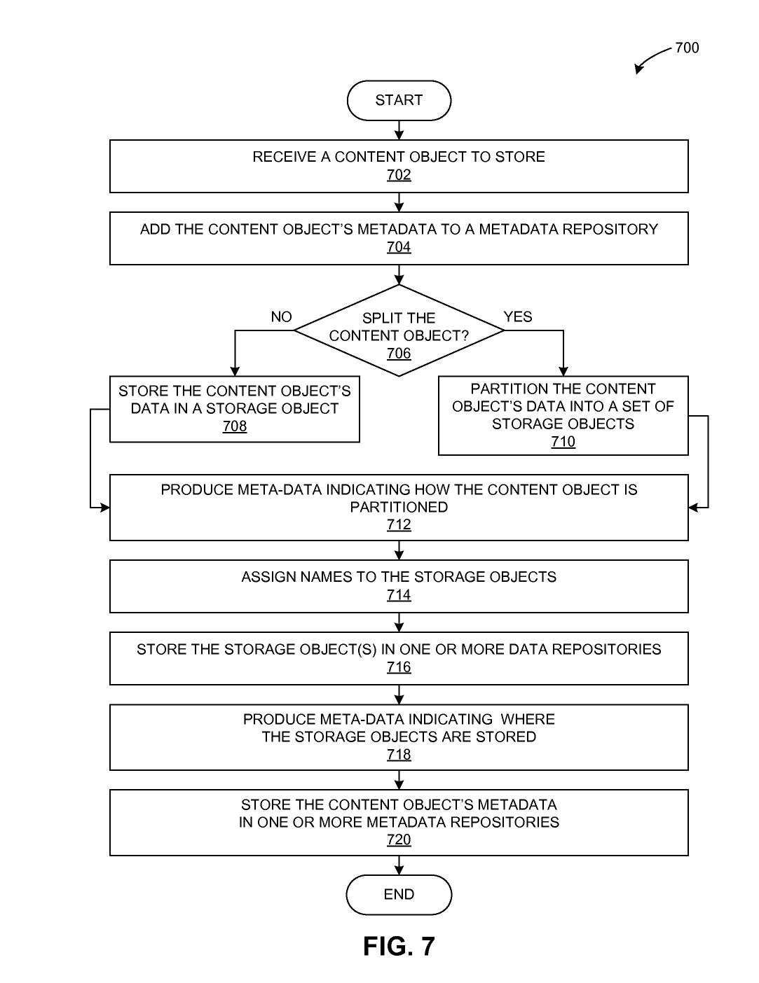

FIG. 7 presents a flow chart illustrating a method 700 for storing information of a content object in one or more repositories in accordance with an embodiment. During operation, the system can receive a content object to store (operation 702). In some embodiments, the system separates the content object's metadata from the content object's data (contents). Doing so allows the system to search through the content object's metadata, without having to scan through the content object's actual data. This way, the system does not compromise the content object while processing a query.

After separating the metadata from the content object, the system can add the content object's metadata to a metadata repository (operation 704). Then, to process the content object's data, the system determines whether the content object's data needs to be split into a collection of storage objects (operation 706). It may be necessary to split the content object's data when the content object is particularly large, or when other users are to be allowed access to portions of the content object. If the system splits a content object into a collection of storage objects, the system may store the storage objects in one data repository or across multiple data repositories, or may store multiple copies of the storage objects in multiple repositories.

If the system determines that the content object does not need to be split into various storage objects, the system can store the content object's data in a single storage object (operation 708). Otherwise, the system can partition the content object's data into a set of storage objects (operation 710). The system then produces metadata indicating how the content object is partitioned (operation 712). This metadata provides information regarding which storage objects make up the content object's data, and where theses storage objects are stored. This metadata is particularly useful when accessing the content object if the content object's data has been stored across multiple repositories. This metadata may also include an ACL that only allows authorized entities to issue queries for the content object's data or metadata.

Once the system produces the metadata, the system assigns names to the storage object (operation 714), and stores the storage objects in one or more data repositories (operation 716). The system can generate these names based on the content object's data or metadata, the content object's hash value, a storage object's hash value, a creation time for the content object, or based on other information for the content object. The data repositories can include a local repository, a cloud storage, or a content centric network. Once the system has stored the storage objects, the system produces additional metadata indicating where the storage objects are stored (operation 718). The system then stores the content object's metadata in one or more metadata repositories (operation 720).

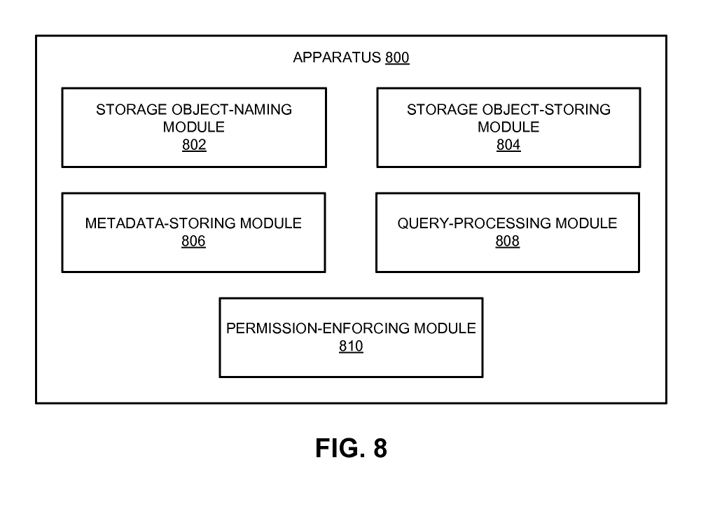

FIG. 8 illustrates an exemplary apparatus that facilitates managing access to content objects or metadata of the content objects in accordance with an embodiment. Apparatus 800 can comprise a plurality of modules, which may communicate with one another via a wired or wireless communication channel. Apparatus 800 may be realized using one or more integrated circuits, and may include fewer or more modules than those shown in FIG. 8. Further, apparatus 800 may be integrated in a computer system, or realized as a separate device which is capable of communicating with other computer systems and/or devices. Specifically, apparatus 800 can comprise a storage object-naming module 802, a storage object-storing module 804, a metadata-storing module 806, a query-processing module 808, and a permission-enforcing module 810.

In some embodiments, storage object-naming module 802 can name storage objects based on storage object characteristics such as the data, metadata, creation value, or the hash value of the object. Storage object-storing module 804 can store storage objects in one or more repositories. Metadata-storing module 806 separates content object data from metadata and organizes the metadata into system metadata and user metadata. Query-processing module 808 can call an API of a federated object store to issue queries or to push query results. Permission-enforcing module 810 can enforce permissions by determining whether a content object's ACL grants a user access to the content object's data.

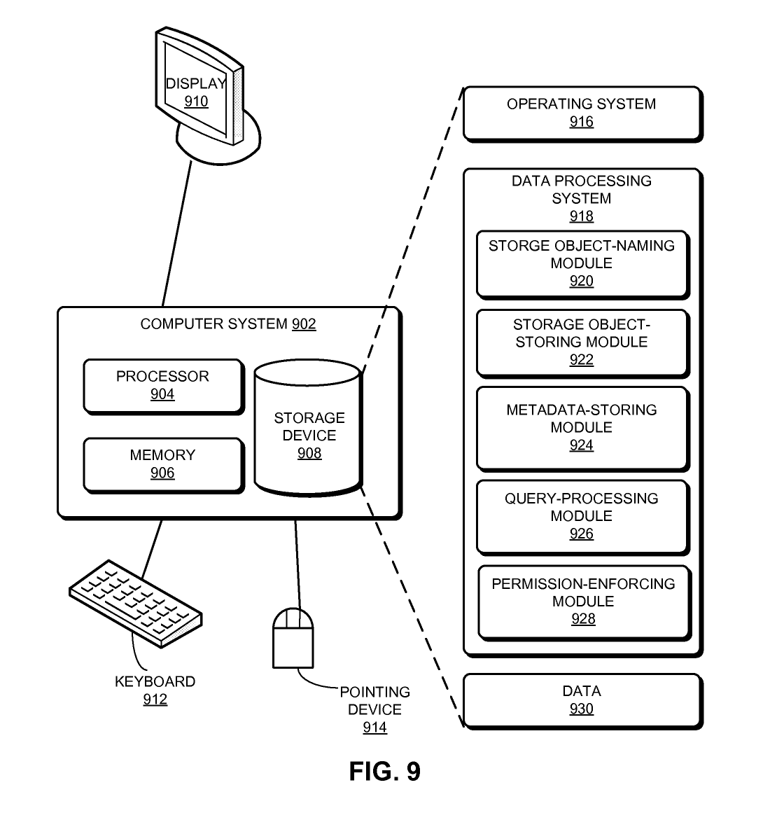

FIG. 9 illustrates an exemplary computer system that facilitates managing access to content objects or metadata of the content objects in accordance with an embodiment. Computer system 902 includes a processor 904, a memory 906, and a storage device 908. Memory 906 can include a volatile memory (e.g., RAM) that serves as a managed memory, and can be used to store one or more memory pools. Furthermore, computer system 902 can be coupled to a display device 910, a keyboard 912, and a pointing device 914. Storage device 908 can store operating system 916, data storing system 918, and data 930.

Data storing system 918 can include instructions, which when executed by computer system 902, can cause computer system 902 to perform methods and/or processes described in this disclosure. Specifically, data storing system 918 may include instructions for naming storage objects based on storage object characteristics (storage object-naming module 920). Further, data storing system 918 can include instructions for storing storage objects in one or more repositories (storage object-storing module 922). Object storing system 918 can also include instructions for separating content object data from metadata and organizing the metadata into system metadata and user metadata (metadata-storing module 924). Further, storing system 918 can also include instructions for issuing a call to an API of a federated object store to issue queries or to push query results (query-processing module 926). Object storing system 918 can also include instructions for enforcing permissions by determining whether a content object's ACL grants a user access to the content object's data (permission-enforcing module 928).

Data 930 can include any data that is required as input or that is generated as output by the methods and/or processes described in this disclosure.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method, comprising:
receiving, by a computer device from a first entity, a request message that includes a command for an object store system, a payload, and user metadata; and
responsive to determining that the command includes a command to store the payload in the object store system, processing the command which involves:
splitting the payload into a set of user-data named content objects;
creating a user-metadata named content object from the user metadata;
determining system contextual metadata associated with the named content objects;
generating a system-metadata named content object for the system contextual metadata;
storing the user-data content objects in a data repository; and
storing the metadata content objects in a metadata repository that includes metadata for a plurality of user-data content objects.

2. The method of claim 1, further comprising, responsive to determining that the command includes a command to access data from the object store system, processing the command and metadata to obtain user data, wherein processing the command involves:
searching through the local metadata repository to identify user-data content objects that match the metadata in the request message;
obtaining, from the data repository, the identified user-data content objects;
obtaining, from the local metadata repository, user-metadata that corresponds to the identified user-data content objects;
assembling the obtained content objects into a response payload; and
sending, to the first entity, a response message that includes at least the response payload, and the user-metadata.

3. The method of claim 1, wherein the method further comprises:
validating the command;
validating the user metadata; and
validating the system metadata.

4. The method of claim 1 where the command includes at least one of:
a create command;
an update command;
an append command;
a merge command;
a read command;
a search command;
a delete command;
an associate command;
a move command;
a notify command;
a subscribe command;
a publish command.

5. The method of claim 1, wherein the user metadata includes one or more of:
a content name;
author information;
group information;
encryption information;
authentication information;
cryptographic signature information;
a relation to other content names;
format information;
a creation time;
a modification time;
a size; and
a notification time

6. The method of claim 1, wherein the system metadata includes one or more of:
author information;
group information;
encryption information;
authentication information;
cryptographic signature information;
a relation to other content names;
format information;
a creation time;
a modification time;
a size;
a notification time;
system identification information;
system authentication information;
system resource information;
system connectivity and network information; and
system peer information.

7. The method of claim 1, wherein the request message from the first entity also includes callback information for the first entity: and
wherein the response payload also includes callback information for the local computer device.

8. The method of claim 7, wherein the callback information includes one or more of:
a callback function;
a callback message queue;
a storage location;
a network address;
a signal;
a network socket;
a file descriptor;
a lock;
a semaphore; and
shared memory.

9. The method of claim 1, wherein the data repository or the metadata repository includes one or more of:
a database;
a random access memory (RAM) device;
a non-volatile storage device; and
a remote storage device.

10. The method of claim 1, further comprising, responsive to determining that the command in the request message includes a command to access data from the object store system:
updating the command in the request message to include a system context;
forwarding the request message with the updated command to a second entity;
receiving, from the second entity, a response message that includes at least a set of response payload content objects, and a user metadata content object; and
forwarding the response message to the first entity.

11. The method of claim 10, wherein the response message from the second entity also includes a system metadata content object, and a command response; and wherein the method further comprises, prior to forwarding the response message:
validating the command response from the response message; and
validating the system metadata content object from the response message.

12. The method of claim 10, wherein the second entity includes one or more of:
a local application; and
a peer network device.

13. The method of claim 10, wherein the local entity and the second entity have exchanged authentication information.

14. The method of claim 10, where communicating with the second entity involves communicating over one or more of:
an inter-process communicating (IPC);
an Internet protocol (IP) network; and
a content centric network (CCN).

15. A non-transitory computer-readable storage medium storing instructions that when executed by a computer cause the computer to perform a method, the method comprising:
receiving, from a first entity, a request message that includes a command for an object store system, a payload, and user metadata; and
responsive to determining that the command includes a command to store the payload in the object store system, processing the command which involves:
splitting the payload into a set of user-data named content objects;
creating a user-metadata named content object from the user metadata;
determining system contextual metadata associated with the named content objects;
generating a system-metadata named content object for the system contextual metadata;
storing the user-data content objects in a data repository; and
storing the metadata content objects in a metadata repository that includes metadata for a plurality of user-data content objects.

16. The storage medium of claim 15, further comprising, responsive to determining that the command includes a command to access data from the object store system, processing the command and metadata to obtain user data, wherein processing the command involves:
searching through the local metadata repository to identify user-data content objects that match the metadata in the request message;
obtaining, from the data repository, the identified user-data content objects;
obtaining, from the local metadata repository, user-metadata that corresponds to the identified user-data content objects;
assembling the obtained content objects into a response payload; and
sending, to the first entity, a response message that includes at least the response payload, and the user-metadata.

17. The storage medium of claim 15, further comprising, responsive to determining that the command in the request message includes a command to access data from the object store system:
updating the command in the request message to include a system context;
forwarding the request message with the updated command to a second entity;
receiving, from the second entity, a response message that includes at least a set of response payload content objects, and a user metadata content object; and
forwarding the response message to the first entity.

18. An apparatus, comprising:
an interfacing module to receive, from a first entity, a request message that includes a command for an object store system, a payload, and user metadata; and
a command-processing module that, responsive to determining that the command includes a command to store the payload in the object store system, is configured to:
split the payload into a set of user-data named content objects;
create a user-metadata named content object from the user metadata;
determine system contextual metadata associated with the named content objects;
generate a system-metadata named content object for the system contextual metadata;
store the user-data content objects in a data repository; and
store the metadata content objects in a metadata repository that includes metadata for a plurality of user-data content objects.

19. The apparatus of claim 18, wherein responsive to the command-processing module determining that the command includes a command to access data from the object store system, the command-processing module is further configured to:
search through the local metadata repository to identify user-data content objects that match the metadata in the request message;
obtain, from the data repository, the identified user-data content objects;
obtain, from the local metadata repository, user-metadata that corresponds to the identified user-data content objects;
assemble the obtained content objects into a response payload; and
send, to the first entity, a response message that includes at least the response payload, and the user-metadata.

20. The apparatus of claim 18, wherein responsive to the command-processing module determining that the command includes a command to access data from the object store system, the command-processing module is further configured to:
update the command in the request message to include a system context;
forward the request message with the updated command to a second entity;
receive, from the second entity, a response message that includes at least a set of response payload content objects, and a user metadata content object; and
forward the response message to the first entity.
